(19) United States
(12) Patent Application Publication
(10) Pub. No.: US 2025/0252296 A1
(43) Pub. Date: Aug. 7, 2025

(54) MULTIDIMENSIONAL PERCEPTUAL INTERACTION METHOD AND SYSTEM

(71) Applicant: CHINA NATIONAL INSTITUTE OF STANDARDIZATION, Beijing (CN)

(72) Inventors: Yunhong ZHANG, Beijing (CN); Yi YANG, Beijing (CN); Feng SI, Beijing (CN); Guoli LIU, Beijing (CN)

(21) Appl. No.: 18/891,421

(22) Filed: Sep. 20, 2024

(30) Foreign Application Priority Data
Feb. 1, 2024 (CN) 202410146826.2

(51) Int. Cl. G06N 3/048; G06N 20/10

(52) U.S. Cl. CPC G06N 3/048; G06N 20/10

(57) ABSTRACT

A multidimensional perceptual interaction method and system are provided. The multidimensional perceptual interaction method includes: collecting historical data of a user, where the historical data includes first interaction data, second interaction data, a corresponding interaction instruction of the first interaction data, and a corresponding interaction instruction of the second interaction data; extracting an interaction feature from the historical data, and training an interaction feature model; establishing a dynamic weight for the interaction instruction in the historical data, and establishing an interaction weight model; establishing an interaction decision-making model based on the interaction feature, the dynamic weight, and the interaction instruction; and inputting to-be-detected interaction data into the interaction feature model to extract a feature, inputting the extracted feature and the dynamic weight into the interaction decision-making model to obtain an interaction instruction, and executing the interaction instruction to provide a multidimensional feedback.

### CROSS REFERENCE TO RELATED APPLICATION

This patent application claims the benefit and priority of Chinese Patent Application No. 202410146826.2, filed with the China National Intellectual Property Administration on Feb. 1, 2024, the disclosure of which is incorporated by reference herein in its entirety as part of the present application.

### TECHNICAL FIELD

The present disclosure relates to the technical field of interaction, and in particular, to a multidimensional perceptual interaction method and system.

### BACKGROUND

With the popularization of smart devices, users have increasingly high requirements for interactive experience. Traditional interaction methods are often limited to a single input mode, such as touch or voice, which may not be intuitive or efficient in certain scenarios. In order to provide richer and more natural interactive experience, a multidimensional perceptual interaction method and system are needed.

### SUMMARY

An objective of the present disclosure is to provide a multidimensional perceptual interaction method and system.

In order to achieve the above objective, the present disclosure is implemented according to the following technical solutions:

The present disclosure includes the following steps:
A. collecting historical data of a user, where the historical data includes first interaction data, second interaction data, a corresponding interaction instruction of the first interaction data, and a corresponding interaction instruction of the second interaction data;
B. extracting an interaction feature from the historical data, and training an interaction feature model;
C. establishing a dynamic weight for the interaction instruction in the historical data, calculating a frequency of using the interaction instruction of the first interaction data to obtain a dynamic weight as a first weight, calculating a frequency of using the interaction instruction of the second interaction data to obtain a dynamic weight as a second weight, optimizing the first weight and the second weight to obtain the dynamic weight, and establishing an interaction weight model;
D. establishing an interaction decision-making model based on the interaction feature, the dynamic weight, and the interaction instruction; and
E. Inputting to-be-detected interaction data into the interaction feature model to extract an interaction feature of the to-be-detected interaction data, inputting the interaction feature of the to-be-detected interaction data and the dynamic weight into the interaction decision-making model to obtain an interaction instruction of the to-be-detected interaction data, and executing the interaction instruction of the to-be-detected interaction data to provide a multidimensional feedback.

Further, the first interaction data is gesture data, the second interaction data is voice data, the gesture data is in an image form, and the voice data is in an audio form.

Further, a method for extracting the interaction feature from the historical data, and training the interaction feature model is as follows:
using a deconvolutional neural network algorithm to extract a feature and train the interaction feature model, wherein the deconvolutional neural network algorithm includes an input layer, a convolutional layer, a deconvolutional layer, an activation function layer, a pooling layer, a fully connected layer, and an output layer;
obtaining a spectrogram by performing Fourier transform on the voice data, normalizing the historical data, inputting the historical data to the convolutional layer so that the convolutional layer extracts a local feature and generates a feature map, and inputting the feature map to the deconvolutional layer such that the deconvolutional layer restores the spatial resolution of the gesture data, extracts a high-level feature, and extracts a feature of the voice data, wherein the feature extraction formulas used by the deconvolutional layer are as follows:
an output of the gesture data in the deconvolutional layer is as follows:

$$\hat{C} p , q = \sum r , {sA}_{p + r , q + s} \cdot {B}_{r , s} + D$$

where Ĉ represents an output feature map, A represents an input feature map, B represents a convolution kernel, D represents a bias term, p and q represent positional indices of the output feature map, and r and s represent positional indices of the convolution kernel; and
an output of the voice data in the deconvolution layer is as follows:

$$\hat{C} p = \sum {rA}_{p + r} \cdot {B}_{r} + D$$

performing a nonlinear transformation on the extracted feature by the activation function layer, inputting a nonlinearly transformed feature into the pooling layer to reduce a spatial dimension of the feature map while preserving an important feature, flattening the feature map by the fully connected layer, performing the nonlinear transformation for the second time, and inputting the feature map into the output layer to output the interaction feature; and
using the interaction feature as a corresponding label of the historical data, inputting the historical data and the interaction feature into the deconvolutional neural network algorithm for training to obtain the interaction feature model.

Further, a method of calculating the frequency of using the interaction instruction of the first interaction data to obtain the dynamic weight as the first weight, and calculating the frequency of using the interaction instruction of the second interaction data to obtain the dynamic weight as the second weight is as follows:
setting a minimum value ξₘᵢₙ for the first weight and the second weight, where a formula for calculating the first weight and the second weight is as follows:

$$ξ = {f}_{i} = \frac{{C}_{i}}{N} , ξ \geq {ξ}_{min}$$

where in the above formula, fᵢ represents a frequency of using an i^{th} instruction, Cᵢ represents a quantity of times of using the i^{th} instruction, and N represents a total quantity of interactions.

Further, a method for optimizing the first weight and the second weight to obtain the dynamic weight, and establishing the interaction weight model includes:
optimizing the first weight and the second weight by using an unscented Kalman filter algorithm;
pre-processing a state variable ξₖ, dividing a pre-processed state variable into a training set and an update set in chronological order, generating a mean value and a covariance matrix, generating a set of sigma points by using the mean value and the covariance matrix of the training set, predicting the sigma points, and updating the sigma points by using the mean value and the covariance matrix of the update set, where the state variable ξₖ contains two variables: the first weight ξ₁ and the second weight ξ₂, and ξₖ=a·ξ₁+b·ξ₂;
calculating a mean value of predicted sigma points based on the predicted sigma points:

$${μ}_{x , k + 1 \vert k} = {\sum }_{i = 0}^{2 n} {w}_{m} {ξ}_{k + 1 , i \vert k}$$

where in the above formula, μ_{x,k+1|k} represents the mean value of the predicted sigma points indicating a predicted mean value for a state x, k+1 at a time point k, wₘ represents a mean value weight, which is used to calculate a weighted mean value of the predicted sigma points, ξ_{k+1,i|k} represents an i^{th} predicted sigma point, and n represents a quantity of sigma points;
calculating a covariance of the predicted sigma points based on the predicted sigma points:

$${P}_{k + 1} {\vert}_{k} = {\sum }_{i = 0}^{2 n} ( {w}_{c} + ( 1 - {α}^{2} + β ) ) ( {ξ}_{k + 1 , i \vert k} - {μ}_{k + 1 \vert k} ) {( {ξ}_{k + 1 , i \vert k} - {μ}_{k + 1 \vert k} )}^{T}$$

where in the above formula, P_{k+1|k} represents a predicted covariance matrix, w_{c} represents a predicted covariance weight, α represents a diffusion parameter, β represents a weight adjustment parameter, μ_{k+1|k} represents the predicted mean value, namely μ_{x,k+1|k}, and T represents the matrix transpose;
calculating a covariance of updated sigma points based on the updated sigma points:

$${S}_{k + 1 {\vert}_{k}} = {\sum }_{i = 0}^{2 n} ( {w}_{c} + ( 1 - {α}^{2} + β ) ) ( {ζ}_{k + 1 , i \vert k} - {μ}_{z , k + 1 \vert k} ) {( {ζ}_{k + 1 , i \vert k} - {μ}_{z , k + 1 \vert k} )}^{T} + R$$

where in the above formula, S_{k+1|k} represents an updated covariance matrix, ζ_{k+1,i|k} represents an i^{th} updated sigma point, μ_{z,k+1|k} represents an updated mean value, namely μ_{x,k+1|k}, and R represents an updated noise covariance matrix; and
calculating a Kalman gain by using a predicted covariance and an updated covariance, updating a state estimate based on time by using the Kalman gain and an updated value, adjusting the first weight and the second weight based on the state estimate ξₖ with a least error, obtaining the dynamic weight by weighted average, and establishing the interaction weight model.

Further, a method for establishing the interaction decision-making model based on the interaction feature, the dynamic weight, and the interaction instruction is as follows:
establishing the interaction decision-making model by using a support vector machine algorithm;
dividing the interaction feature, the dynamic weight, and the interaction instruction into a training sample set and a test sample set, and training the interaction decision-making model by using the training sample set, and finding an optimal decision boundary by the support vector machine algorithm to enable the interaction decision-making model to map the interaction feature and the dynamic weight onto the interaction instruction;
combining the interaction feature and the dynamic weight into a feature vector, using the interaction instruction as a classification category, setting a regularization parameter C, and using a radial basis function (RBF) kernel as a kernel function:

$$k ( ‖ {m}_{i} - {m}_{j} ‖ ) = exp \frac{- {‖ {m}_{i} - {m}_{j} ‖}^{2}}{{( 2 * σ )}^{2}}$$

where in the above formula, k represents the kernel function, ∥mᵢ-mⱼ∥ represents a linear distance between mᵢ and mⱼ, the mᵢ and the mⱼ represent coordinates of two feature vectors, and σ represents a width parameter of a function;
an objective function of the support vector machine algorithm is as follows:

$$J = \frac{1}{2} {\sum }_{i , j = 1}^{\vert D \vert} {α}_{i} {α}_{j} {x}_{1} {x}_{j} K ( ‖ {m}_{i} - {m}_{j} ‖ )$$

where in the above formula, D represents the training sample set, αᵢ and αⱼ represent Lagrangian multipliers, and xᵢ and xⱼ represent sample category labels; and
a constraint for the Lagrangian multiplier is as follows:

$$[ {α}_{i} \geq 0 ∀ i ] [ {\sum }_{i = 1}^{n} {α}_{i} {x}_{i} = 0 ]$$

training the interaction decision-making model by using the support vector machine algorithm based on the training sample set, such that the interaction decision-making model finds a hyperplane to maximize an interval between different interaction instructions, and establishing the interaction decision-making model.

Further, a method for executing the interaction instruction of the to-be-detected interaction data to provide the multidimensional feedback is as follows:
when an instruction of gesture data and an instruction of voice data in the to-be-detected interaction data are contradictory, skipping execution of the interaction instruction of the to-be-detected interaction data; when an instruction of gesture data and an instruction of voice data in the to-be-detected interaction data are the same, executing the interaction instruction of the to-be-detected interaction data; or when an instruction of gesture data and an instruction of voice data in the to-be-detected interaction data are different but not contrary, executing the two different interaction instructions of the to-be-detected interaction data,
where, a plurality of dimensions includes visual, auditory, and tactile dimensions.

A multidimensional perceptual interaction system includes:
a collection module configured to collect historical data of a user, where the historical data includes first interaction data, second interaction data, a corresponding interaction instruction of the first interaction data, and a corresponding interaction instruction of the second interaction data;
an optimization module configured to optimize a first weight and a second weight to obtain a dynamic weight, and establish an interaction weight model;
a calculation module configured to establish the dynamic weight for the interaction instruction in the historical data, calculate a frequency of using the interaction instruction of the first interaction data to obtain a dynamic weight as a first weight, calculate a frequency of using the interaction instruction of the second interaction data to obtain a dynamic weight as a second weight, optimize the first weight and the second weight to obtain the dynamic weight, and establish the interaction weight model; and
an output module configured to input to-be-detected interaction data into an interaction feature model to extract an interaction feature of the to-be-detected interaction data, input the interaction feature of the to-be-detected interaction data and the dynamic weight into an interaction decision-making model to obtain an interaction instruction of the to-be-detected interaction data, and execute the interaction instruction of the to-be-detected interaction data to provide a multidimensional feedback.

The present disclosure has the following beneficial effects:

The present disclosure significantly enhances operational convenience and interaction efficiency of an intelligent device by integrating gesture and voice interaction. The present disclosure not only optimizes user experience, making the user experience more intuitive and natural, but also adapts to a personalized habit of a user based on a dynamic weight, effectively reducing a possibility of misoperation.

### BRIEF DESCRIPTION OF THE DRAWINGS

FIG. 1 is a flowchart according to the present disclosure.

### DETAILED DESCRIPTION OF THE EMBODIMENTS

The present disclosure is further described in detail below with reference to specific embodiments. The exemplary embodiments and description of the present disclosure are intended to explain the present disclosure herein, but are not intended to limit the present disclosure.

The present disclosure includes the following steps:

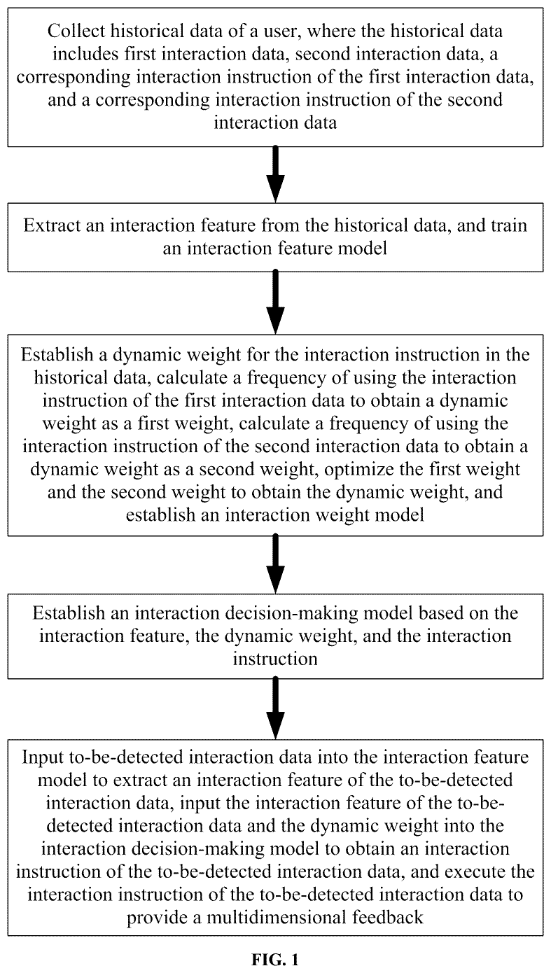

As shown in FIG. 1, embodiments include the following steps:

An objective of the present disclosure is to provide a multidimensional perceptual interaction method and system.

In order to achieve the above objective, the present disclosure is implemented according to following technical solutions:

The present disclosure includes following steps:
A. Collect historical data of a user, where the historical data includes first interaction data, second interaction data, a corresponding interaction instruction of the first interaction data, and a corresponding interaction instruction of the second interaction data.
B. Extract an interaction feature from the historical data, and train an interaction feature model.
C. Establish a dynamic weight for the interaction instruction in the historical data, calculate a frequency of using the interaction instruction of the first interaction data to obtain a dynamic weight as a first weight, calculate a frequency of using the interaction instruction of the second interaction data to obtain a dynamic weight as a second weight, optimize the first weight and the second weight to obtain the dynamic weight, and establish an interaction weight model.
D. Establish an interaction decision-making model based on the interaction feature, the dynamic weight, and the interaction instruction.
E. Input to-be-detected interaction data into the interaction feature model to extract an interaction feature of the to-be-detected interaction data, input the interaction feature of the to-be-detected interaction data and the dynamic weight into the interaction decision-making model to obtain an interaction instruction of the to-be-detected interaction data, and execute the interaction instruction of the to-be-detected interaction data to provide a multidimensional feedback.

In the embodiments, there are a total of three sets of historical data. A first set of historical data is an image of making an upward sliding gesture by the user to increase the brightness of a current room, and an audio made by the user to turn off a kitchen light. A second set of historical data is an image of making a downward sliding gesture by the user to decrease the brightness of the current room, and an audio made by the user for decreasing the brightness of the current room. A third set of historical data is an image of making an upward sliding gesture by the user to increase the brightness of the current room, and an audio made by the user for turning off the kitchen light.

In the embodiments, the first interaction data is gesture data, the second interaction data is voice data, the gesture data is in an image form, and the voice data is in an audio form.

In the embodiments, a method for extracting the interaction feature from the historical data, and training the interaction feature model is as follows:
using a deconvolutional neural network algorithm to extract a feature and train the interaction feature model, where the deconvolutional neural network algorithm includes an input layer, a convolutional layer, a deconvolutional layer, an activation function layer, a pooling layer, a fully connected layer, and an output layer;
obtaining a spectrogram by performing Fourier transform on the voice data, normalizing the historical data, inputting the historical data into the convolutional layer such that the convolutional layer extracts a local feature and generates a feature map, and inputting the feature map into the deconvolutional layer so that the deconvolutional layer restores spatial resolution of the gesture data, extracts a high-level feature, and extracts a feature of the voice data, where feature extraction formulas used by the deconvolutional layer are as follows:
an output of the gesture data in the deconvolutional layer is as follows:

$$\hat{C} p , q = \sum r , {sA}_{p + r , q + s} \cdot {B}_{r , s} + D$$

where Ĉ represents an output feature map, A represents an input feature map, B represents a convolution kernel, D represents a bias term, p and q represent positional indexes of the output feature map, and r and s represent positional indexes of the convolution kernel; and an output of the voice data in the deconvolutional layer is as follows:

$$\hat{C} p = \sum {rA}_{p + r} \cdot {B}_{r} + D$$

performing a nonlinear transformation on the extracted feature by the activation function layer, inputting a nonlinearly transformed feature into the pooling layer to reduce a spatial dimension of the feature map while preserving an important feature, flattening the feature map by the fully connected layer, performing the nonlinear transformation for the a second time, and inputting the feature map into the output layer to output the interaction feature; and
using the interaction feature as a corresponding label of the historical data, inputting the historical data and the interaction feature into the deconvolutional neural network algorithm for training to obtain the interaction feature model.

In the embodiments, the interaction features of the three sets of historical data are as follows:
In the first set of historical data, the gesture data has a trajectory length of upward 150 pixels, a trajectory speed of 20 pixels/second, a trajectory smoothness of 0.8, and gesture duration of 2 seconds, and the voice data has a frequency energy distribution [0.2, 0.3, 0.2, 0.1, 0.1, 0.1] and a rhythm mode [0.6, 0.5, 0.4, 0.5].

In the second set of historical data, the gesture data has a trajectory length of 100 pixels downward, a trajectory speed of 15 pixels/second, trajectory smoothness of 0.7, and a gesture duration of 3 seconds, and the voice data has a frequency energy distribution [0.1, 0.2, 0.3, 0.2, 0.1, 0.1] and a rhythm mode [0.5, 0.5, 0.4, 0.6].

In the third set of historical data, the gesture data has a trajectory length of upward 200 pixels, a trajectory speed of 25 pixels/second, trajectory smoothness of 0.9, and gesture duration of 1.5 seconds, and the voice data has a frequency energy distribution [0.2, 0.3, 0.2, 0.1, 0.1, 0.1] and a rhythm mode [0.6, 0.5, 0.4, 0.5].

In the embodiments, a method for calculating the frequency of using the interaction instruction of the first interaction data to obtain the dynamic weight as the first weight, and calculating the frequency of using the interaction instruction of the second interaction data to obtain the dynamic weight as the second weight is as follows:
setting a minimum value ξₘᵢₙ for the first weight and the second weight, where ξₘᵢₙ=0.2, and a formula for calculating the first weight and the second weight is as follows:

$$ξ = {f}_{i} = \frac{{C}_{i}}{N} , ξ \geq {ξ}_{min} = 0.2$$

In the above formula, fᵢ represents a frequency of using an i^{th} instruction, Cᵢ represents a quantity of times of the i^{th} instruction is used, and N represents a total quantity of interactions.

In the embodiments, for the three sets of historical data, the first weight and the second weight are as follows:

For the first set of historical data, the first weight is 1 for an instruction of increasing the brightness, 0.2 for an instruction of decreasing the brightness, and 0.2 for an instruction of turning off the kitchen light; and the second weight is 0.2 for the instruction of increasing the brightness, 0.2 for the instruction of decreasing the brightness, and 1 for the instruction of turning off the kitchen light.

For the second set of historical data, the first weight is 0.5 for the instruction of increasing the brightness, 0.5 for the instruction of decreasing the brightness, and 0.2 for the instruction of turning off the kitchen light; and the second weight is 0.2 for the instruction of increasing the brightness, 0.5 for the instruction of decreasing the brightness, and 0.5 for the instruction of turning off the kitchen light.

For the third set of historical data, the first weight is 0.66 for the instruction of increasing the brightness, 0.33 for the instruction of decreasing the brightness, and 0.2 for the instruction of turning off the kitchen light; and the second weight is 0.2 for the instruction of increasing the brightness, 0.33 for the instruction of decreasing the brightness, and 0.66 for the instruction of turning off the kitchen light.

In the embodiments, a method for optimizing the first weight and the second weight to obtain the dynamic weight, and establishing the interaction weight model includes:
optimizing the first weight and the second weight by using an unscented Kalman filter algorithm;
pre-processing a state variable ξₖ, dividing a pre-processed state variable into a training set and an update set in chronological order, generating a mean value and a covariance matrix, generating a set of sigma points by using the mean value and the covariance matrix of the training set, predicting the sigma points, and updating the sigma points by using the mean value and the covariance matrix of the update set, where the state variable ξₖ contains two variables: the first weight ξ₁ and the second weight ξ₂, where ξₖ=a·ξ₁+b·ξ₂, a=1, and b=1.5;
calculating a mean value of the predicted sigma points based on the predicted sigma points:

$${μ}_{x , k + 1 \vert k} = {\sum }_{i = 0}^{2 n} {w}_{m} {ξ}_{k + 1 , i \vert k}$$

where in the above formula, μ_{x,k+1|k} represents the mean value of the predicted sigma points indicating a predicted mean value for a state x, k+1 at a time point k, wₘ represents a mean value weight, which is used to calculate a weighted mean value of the predicted sigma points, ξ_{k+1,i|k} represents an i^{th} predicted sigma point, and n represents a quantity of sigma points;
calculating a covariance of the predicted sigma points based on the predicted sigma points:

$${P}_{k + 1} {\vert}_{k} = {\sum }_{i = 0}^{2 n} ( {w}_{c} + ( 1 - {a}^{2} + β ) ) ( {ξ}_{k + 1 , i \vert k} - {μ}_{k + 1 \vert k} ) {( {ξ}_{k + 1 , i \vert k} - {μ}_{k + 1 \vert k} )}^{T}$$

where in the above formula, P_{k+1|k} represents a predicted covariance matrix, w_{c} represents a predicted covariance weight, α represents a diffusion parameter, β represents a weight adjustment parameter, μ_{k+1|k} represents the predicted mean value, namely μ_{x,k+1|k}, and T represents a matrix transpose;
calculating a covariance of updated sigma points based on the updated sigma points:

$${S}_{k + 1 \vert k} = {\sum }_{i = 0}^{2 n} ( {w}_{c} + ( 1 - {a}^{2} + β ) ) ( {ξ}_{k + 1 , i \vert k} - {μ}_{z , k + 1 \vert k} ) {( {ξ}_{k + 1 , i \vert k} - {μ}_{z , k + 1 \vert k} )}^{T} + R$$

where in the above formula, S_{k+1|k} represents an updated covariance matrix, ζ_{k+1,i|k} represents an i^{th} updated sigma point, μ_{z,k+1|k} represents an updated mean value, namely μ_{x,k+1|k}, and R represents an updated noise covariance matrix; and
calculating a Kalman gain by using a predicted covariance and an updated covariance, updating a state estimate based on time by using the Kalman gain and an updated value, adjusting the first weight and the second weight based on the state estimate ξₖ with a smallest error, obtaining the dynamic weight through weighted average, and establishing the interaction weight model.

In the embodiments, the dynamic weight is 0.42 for the instruction of increasing the brightness, 0.8 for the instruction of turning off the kitchen light, and 0.58 for the instruction of decreasing the brightness.

In the embodiments, a method for establishing the interaction decision-making model based on the interaction feature, the dynamic weight, and the interaction instruction is as follows:
establishing the interaction decision-making model by using a support vector machine algorithm;
dividing the interaction feature, the dynamic weight, and the interaction instruction into a training sample set and a test sample set based on a ratio of 2:1, and training the interaction decision-making model by using the training sample set, and finding, by the support vector machine algorithm, an optimal decision boundary to enable the interaction decision-making model to map the interaction feature and the dynamic weight onto the interaction instruction;
combining the interaction feature and the dynamic weight into a feature vector, using the interaction instruction as a classification category, setting a regularization parameter C, and using an RBF kernel as a kernel function:

$$k ( ‖ {m}_{i} - {m}_{j} ‖ ) = exp \frac{- {‖ {m}_{i} - {m}_{j} ‖}^{2}}{{( 2 ⋆ σ )}^{2}}$$

where in the above formula, k represents the kernel function, ∥mᵢ-mⱼ∥ represents a straight-line distance between mᵢ and mⱼ, the mᵢ and the mⱼ represent coordinates of two feature vectors, and σ represents a width parameter of a function;
an objective function of the support vector machine algorithm is as follows:

$$J = \frac{1}{2} {{\sum }_{i , j - 1}}^{\vert D \vert} {α}_{i} {α}_{j} {x}_{i} {x}_{j} K ( ‖ {m}_{i} - {m}_{j} ‖ )$$

where in the above formula, D represents the training sample set, αᵢ and αⱼ represent Lagrangian multipliers, and xᵢ and xⱼ represent sample category labels; and
a constraint for the Lagrange multiplier is as follows:

$$[ {α}_{i} \geq 0 ∀ i ] [ {{\sum }_{i - 1}}^{n} {α}_{i} {x}_{i} = 0 ]$$

training the interaction decision-making model by using the support vector machine algorithm based on the training sample set, such that the interaction decision-making model finds a hyperplane to maximize an interval between different interaction instructions, and establishing the interaction decision-making model.

In the embodiments, a method for executing the interaction instruction of the to-be-detected interaction data to provide the multidimensional feedback is as follows:
when an instruction of gesture data and an instruction of voice data in the to-be-detected interaction data are contrary, skipping execution of the interaction instruction of the to-be-detected interaction data; when an instruction of gesture data and an instruction of voice data in the to-be-detected interaction data are the same, executing the interaction instruction of the to-be-detected interaction data; or when an instruction of gesture data and an instruction of voice data in the to-be-detected interaction data are different but not contrary, executing the two different interaction instructions of the to-be-detected interaction data.

In the embodiments, the interaction feature obtained for the to-be-detected interaction data by inputting the to-be-detected interaction data into the interaction feature model is as follows: the trajectory length is upward 175 pixels, the trajectory speed is 23 pixels/second, the trajectory smoothness is 0.8, the gesture duration is 2.5 seconds, the frequency energy distribution is [0.2, 0.3, 0.2, 0.1, 0.1, 0.1], and the rhythm mode is [0.6, 0.5, 0.4, 0.5].

The interaction instruction obtained for the to-be-detected interaction data by inputting the interaction feature of the to-be-detected interaction data and the dynamic weight of the historical data into the interaction decision-making model is as follows: The instruction of the gesture data is to increase the brightness of room, and the instruction of the voice data is to increase the brightness of room.

When the instruction of the gesture data is the same as the instruction of the voice data, the interaction instruction of the to-be-detected interaction data is executed to provide the multidimensional feedback.

A multidimensional perceptual interaction system includes:
a collection module configured to collect historical data of a user, where the historical data includes first interaction data, second interaction data, a corresponding interaction instruction of the first interaction data, and a corresponding interaction instruction of the second interaction data;
an optimization module configured to optimize a first weight and a second weight to obtain a dynamic weight, and establish an interaction weight model;
a calculation module configured to establish the dynamic weight for the interaction instruction in the historical data, calculate a frequency of using the interaction instruction of the first interaction data to obtain a dynamic weight as a first weight, calculate a frequency of using the interaction instruction of the second interaction data to obtain a dynamic weight as a second weight, optimize the first weight and the second weight to obtain the dynamic weight, and establish the interaction weight model; and
an output module configured to input to-be-detected interaction data into an interaction feature model to extract an interaction feature of the to-be-detected interaction data, input the interaction feature of the to-be-detected interaction data and the dynamic weight into an interaction decision-making model to obtain an interaction instruction of the to-be-detected interaction data, and execute the interaction instruction of the to-be-detected interaction data to provide a multidimensional feedback.

The technical solutions of the present disclosure are not limited to the above specific embodiments, and all technical variations made according to the technical solutions of the present disclosure fall within the protection scope of the present disclosure.

What is claimed is:

1. A multidimensional perceptual interaction method, comprising following steps:
A. collecting historical data of a user, wherein the historical data comprises first interaction data, second interaction data, a corresponding interaction instruction of the first interaction data, and a corresponding interaction instruction of the second interaction data;
B. extracting an interaction feature from the historical data, and training an interaction feature model;
C. establishing a dynamic weight for the interaction instruction in the historical data, calculating a frequency of using the interaction instruction of the first interaction data to obtain a dynamic weight as a first weight, calculating a frequency of using the interaction instruction of the second interaction data to obtain a dynamic weight as a second weight, optimizing the first weight and the second weight to obtain the dynamic weight, and establishing an interaction weight model;
D. establishing an interaction decision-making model based on the interaction feature, the dynamic weight, and the interaction instruction; and
E. inputting to-be-detected interaction data into the interaction feature model to extract an interaction feature of the to-be-detected interaction data, inputting the interaction feature of the to-be-detected interaction data and the dynamic weight into the interaction decision-making model to obtain an interaction instruction of the to-be-detected interaction data, and executing the interaction instruction of the to-be-detected interaction data to provide a multidimensional feedback.

2. The multidimensional perceptual interaction method according to claim 1, wherein in the step A, the first interaction data is gesture data, the second interaction data is voice data, the gesture data is in an image form, and the voice data is in an audio form.

3. The multidimensional perceptual interaction method according to claim 1, wherein in the step B, a method for extracting the interaction feature from the historical data, and training the interaction feature model is as follows:
using a deconvolutional neural network algorithm to extract a feature and train the interaction feature model, wherein the deconvolutional neural network algorithm comprises an input layer, a convolutional layer, a deconvolutional layer, an activation function layer, a pooling layer, a fully connected layer, and an output layer;
obtaining a spectrogram by performing Fourier transform on the voice data, normalizing the historical data, inputting the historical data into the convolutional layer such that the convolutional layer extracts a local feature and generates a feature map, and inputting the feature map into the deconvolutional layer such that the deconvolutional layer restores spatial resolution of the gesture data, extracts a high-level feature, and extracts a feature of the voice data, wherein feature extraction formulas used by the deconvolutional layer are as follows:
an output of the gesture data in the deconvolutional layer is as follows:
$$\hat{C} p , q = \sum r , {sA}_{p + r , q + s} \cdot {B}_{r , s} + D$$
wherein Ĉ represents an output feature map, A represents an input feature map, B represents a convolution kernel, D represents a bias term, p and q represent positional indexes of the output feature map, and r and s represent positional indexes of the convolution kernel; and
an output of the voice data in the deconvolutional layer is as follows:
$$Cp \text{?} = \sum r {A}_{p + r} \cdot {B}_{r} + D$$
$$\text{?} \text{indicates text missing or illegible when filed}$$
performing a nonlinear transformation on the extracted feature by the activation function layer, inputting a nonlinearly transformed feature into the pooling layer to reduce a spatial dimension of the feature map, flattening the feature map through the fully connected layer, performing the nonlinear transformation for the second time, and inputting the feature map into the output layer to output the interaction feature; and
using the interaction feature as a corresponding label of the historical data, inputting the historical data and the interaction feature into the deconvolutional neural network algorithm for training to obtain the interaction feature model.

4. The multidimensional perceptual interaction method according to claim 1, wherein in the step C, a method for calculating the frequency of using the interaction instruction of the first interaction data to obtain the dynamic weight as the first weight, and calculating the frequency of using the interaction instruction of the second interaction data to obtain the dynamic weight as the second weight is as follows:
setting a minimum value ξₘᵢₙ for the first weight and the second weight, wherein a formula for calculating the first weight and the second weight is as follows:
$$ξ = {f}_{i} = \frac{{C}_{i}}{N} \text{?} {ξ}_{min} \geq 0.2$$
$$\text{?} \text{indicates text missing or illegible when filed}$$
wherein in the above formula, fᵢ represents a frequency of using an i^{th} instruction, Cᵢ represents a quantity of times of using the i^{th} instruction, and N represents a total quantity of interactions.

5. The multidimensional perceptual interaction method according to claim 1, wherein in the step C, a method for optimizing the first weight and the second weight to obtain the dynamic weight, and establishing the interaction weight model is as follows:
optimizing the first weight and the second weight by using an unscented Kalman filter algorithm;
pre-processing a state variable ξₖ, dividing a pre-processed state variable into a training set and an update set in chronological order, generating a mean value and a covariance matrix, generating a set of sigma points by using the mean value and the covariance matrix of the training set, predicting the sigma points, and updating the sigma points by using the mean value and the covariance matrix of the update set, wherein the state variable ξₖ contains two variables: the first weight ξ₁ and the second weight ξ₂, and ξₖ=a·ξ₁+b·ξ₂;
calculating a mean value of predicted sigma points based on the predicted sigma points:
$${μ}_{x , k + 1 \vert k} = {\sum }_{i = 0}^{2 n} {w}_{m} {ξ}_{k + 1 , i \vert k}$$
wherein in the above formula, μ_{x,k+1|k} represents the mean value of the predicted sigma points, which indicates a predicted mean value for a state x, k+1 at a time point k, wₘ represents a mean value weight, which is used to calculate a weighted mean value of the predicted sigma points, ξ_{k+1,i|k} represents an i^{th} predicted sigma point, and n represents a quantity of sigma points;
calculating a covariance of the predicted sigma points based on the predicted sigma points:
$${P}_{k + 1} {\vert}_{k} = {\sum }_{i = 0}^{2 n} ( {w}_{c} + ( 1 - {a}^{2} + β ) ) ( {ξ}_{k + 1 , i \vert k} - {μ}_{k + 1 \vert k} ) {( {ξ}_{k + 1 , i \vert k} - {μ}_{k + 1 \vert k} )}^{T}$$
wherein in the above formula, P_{k+1|k} represents a predicted covariance matrix, w_{c} represents a predicted covariance weight, α represents a diffusion parameter, β represents a weight adjustment parameter, μ_{k+1|k} represents the predicted mean value, namely μ_{x,k+1|k}, and T represents matrix transpose;
calculating a covariance of updated sigma points based on the updated sigma points:
$${S}_{k + 1 \vert k} = {\sum }_{i = 0}^{2 n} ( {w}_{c} + ( 1 - {a}^{2} + β ) ) ( {ξ}_{k + 1 , i \vert k} - {μ}_{z , k + 1 \vert k} ) {( {ξ}_{k + 1 , i \vert k} - {μ}_{z , k + 1 \vert k} )}^{T} + R$$
wherein in the above formula, S_{k+1|k} represents an updated covariance matrix, ζ_{k+1,i|k} represents an i^{th} updated sigma point, μ_{z,k+1|k} represents an updated mean value, namely μ_{x,k+1|k}, and R represents an updated noise covariance matrix; and
calculating a Kalman gain by using a predicted covariance and an updated covariance, updating a state estimate based on time by using the Kalman gain and an updated value, adjusting the first weight and the second weight based on the state estimate ξₖ with a smallest error, obtaining the dynamic weight through weighted average, and establishing the interaction weight model.

6. The multidimensional perceptual interaction method according to claim 1, wherein in the step D, a method for establishing the interaction decision-making model based on the interaction feature, the dynamic weight, and the interaction instruction is as follows:
establishing the interaction decision-making model by using a support vector machine algorithm;
dividing the interaction feature, the dynamic weight, and the interaction instruction into a training sample set and a test sample set, and training the interaction decision-making model by using the training sample set, and finding, by the support vector machine algorithm, an optimal decision boundary to enable the interaction decision-making model to map the interaction feature and the dynamic weight onto the interaction instruction;
combining the interaction feature and the dynamic weight into a feature vector, using the interaction instruction as a classification category, setting a regularization parameter C, and using a radial basis function (RBF) kernel as a kernel function:
$$k ( ‖ {m}_{i} - {m}_{j} ‖ ) = exp \frac{- {‖ {m}_{i} - {m}_{j} ‖}^{2}}{{( 2 ⋆ σ )}^{2}}$$
wherein in the above formula, k represents the kernel function, ∥mᵢ-mⱼ∥ represents a straight-line distance between mᵢ and mⱼ, the mᵢ and the mⱼ represent coordinates of two feature vectors, and σ represents a width parameter of a function;
an objective function of the support vector machine algorithm is as follows:
$$J = \frac{1}{2} {{\sum }_{i , j - 1}}^{\vert D \vert} {α}_{i} {α}_{j} {x}_{i} {x}_{j} K ( ‖ {m}_{i} - {m}_{j} ‖ )$$
wherein in the above formula, D represents the training sample set, αᵢ and αⱼ represent Lagrangian multipliers, and xᵢ and xⱼ represent sample category labels; and
a constraint for the Lagrange multiplier is as follows:
$$[ {α}_{i} \geq 0 ∀ i ] [ {{\sum }_{i - 1}}^{n} {α}_{i} {x}_{i} = 0 ]$$
training the interaction decision-making model by using the support vector machine algorithm based on the training sample set, such that the interaction decision-making model finds a hyperplane to maximize an interval between different interaction instructions, and establishing the interaction decision-making model.

7. The multidimensional perceptual interaction method according to claim 1, wherein in the step E, a method for executing the interaction instruction of the to-be-detected interaction data to provide the multidimensional feedback is as follows:
when an instruction of gesture data and an instruction of voice data in the to-be-detected interaction data are contrary, skipping executing the interaction instruction of the to-be-detected interaction data; when an instruction of gesture data and an instruction of voice data in the to-be-detected interaction data are the same, executing the interaction instruction of the to-be-detected interaction data; or when an instruction of gesture data and an instruction of voice data in the to-be-detected interaction data are different but not contrary, executing the two different interaction instructions of the to-be-detected interaction data,
wherein a plurality of dimensions comprise visual, auditory, and tactile dimensions.

8. A multidimensional perceptual interaction system, comprising:
a collection module configured to collect historical data of a user, wherein the historical data comprises first interaction data, second interaction data, a corresponding interaction instruction of the first interaction data, and a corresponding interaction instruction of the second interaction data;
an optimization module configured to optimize a first weight and a second weight to obtain a dynamic weight, and establish an interaction weight model;
a calculation module configured to establish the dynamic weight for the interaction instruction in the historical data, calculate a frequency of use of the interaction instruction of the first interaction data to obtain a dynamic weight as a first weight, calculate a frequency of using the interaction instruction of the second interaction data to obtain a dynamic weight as a second weight, optimize the first weight and the second weight to obtain the dynamic weight, and establish the interaction weight model; and
an output module configured to input to-be-detected interaction data into an interaction feature model to extract an interaction feature of the to-be-detected interaction data, input the interaction feature of the to-be-detected interaction data and the dynamic weight into an interaction decision-making model to obtain an interaction instruction of the to-be-detected interaction data, and execute the interaction instruction of the to-be-detected interaction data to provide a multidimensional feedback.
